(19) United States
(12) Patent Application Publication
(10) Pub. No.: US 2008/0141278 A1
(43) Pub. Date: Jun. 12, 2008

(54) System and Method for Enhanced Spam Detection

(75) Inventors: William H. Dudley, Lovettsville, VA (US); Robert C. Lovell, Leesburg, VA (US)

Correspondence Address: EDELL, SHAPIRO & FINNAN, LLC, 1901 RESEARCH BOULEVARD, SUITE 400, ROCKVILLE, MD, 20850, US

(73) Assignee: SYBASE 365, INC., Chantilly, VA (US)

(21) Appl. No.: 11/949,949

(22) Filed: Dec. 4, 2007

Related U.S. Application Data
(60) Provisional application No. 60/873,257, filed on Dec. 7, 2006.

(51) Int. Cl. G06F 3/00

(52) U.S. Cl. 719/313

(57) ABSTRACT

A service that leverages an innovatively extended version of Bayes' Theorem to provide comprehensive spam detection and optional spam elimination capabilities within established wireless messaging paradigms such as, possibly inter alia, Short Message Service, Multimedia Message Service, Wireless Application Protocol, and IP Multimedia Subsystem. The service may optionally leverage the capabilities of a centrally-located Messaging Inter-Carrier Vendor.

This application claims the benefit of U.S. Provisional Patent Application No. 60/873,257, filed on Dec. 7, 2006, which is herein incorporated by reference in its entirety.

### BACKGROUND

1. Field of the Invention

The present invention relates generally to telecommunications services. More particularly, the present invention relates to capabilities that enhance substantially the value and usefulness of various messaging paradigms including, inter alia, Short Message Service (SMS), Multimedia Message Service (MMS), Wireless Application Protocol (WAP), Internet Protocol (IP) Multimedia Subsystem (IMS), Instant Messenger (IM), etc.

2. Background of the Invention

As the ‘wireless revolution’ continues to march forward the importance to a Mobile Subscriber (MS)—for example a user of a Wireless Device (WD) such as, inter alia, a mobile telephone, a BlackBerry, etc. that is serviced by a Wireless Carrier (WC)—of their WD grows substantially. One consequence of such a growing importance is the resulting ubiquitous nature of WDs—i.e., MSs carry them at almost all times and use them for an ever-increasing range of activities.

As MSs employ their WDs for ever more activities their WDs become increasingly more vulnerable to a range of undesirable behaviors. One undesirable behavior is spam (i.e., unsolicited, undesired bulk messages). Internet-based Electronic Mail (E-mail) spam has become notorious. As benn noted by NetZero, spam “ . . . is the Internet's equivalent of junk mail. The Internet abuse generally referred to as spamming ranges from annoyances like electronic mass mailings, mass advertisements, junk email, chain letters, and off-topic newsgroup postings on one hand to more serious abuses such as perpetration of scams or confidence games, transmission of fraudulent product or service promotions and harassing or threatening emails on the other. All types of spam waste the valuable time, energy and resources of the recipients, the service providers involved, and the whole Internet community.”

Numerous efforts or initiatives have arisen in response to the growth of Internet-based E-mail spam including, inter alia, purely technical efforts (such as, e.g., the SpamHaus project) and legal initiatives (such as, e.g., the CAN-SPAM Act of 2003 [Controlling the Assault of Non-Solicited Pornography and Marketing Act]).

Perhaps inevitably, spam artists recently have begun targeting WDs within wireless messaging ecosystems. In fact, the term “SpaSMS” has recently been coined to describe SMS-based spam.

As a result a range of new, enhanced anti-spam mechanisms are necessary to identify or detect, and optionally eliminate, spam within a wireless messaging ecosystem.

The present invention provides such enhanced spam detection and elimination capabilities and addresses various of the (not insubstantial) challenges that are associated with same.

### SUMMARY OF THE INVENTION

Embodiments of the present invention employ an innovatively extended version of Bayes' Theorem to provide comprehensive spam detection and optional spam elimination capabilities within established wireless messaging paradigms such as, possibly inter alia, SMS, MMS, IMS, etc.

More particularly, embodiments of the present invention provide a method for detecting undesirable or “spam” messages being passed through a wireless network. The method includes intercepting a message at a messaging inter-carrier vendor (MICV) that was sent over a wireless network. The message is passed to an application server that is in communication with a database. The application server the calculates a probability that the message is an undesirable message. Preferably, the calculation takes into account, among other things, one or more of words, expressions, shortcuts, idioms, and abbreviations, in the message.

In addition, the probability calculation may be based on the formula

Pr(spam|words)=(Pr(words|spam)*Pr(spam))/(Pr(words))*AF

wherein the probability that the message is undesirable (spam) given the message includes certain words is equal to (a) the probability of finding those certain words in an undesirable message (Pr(words|spam)) times the probability that any message is undesirable (Pr(spam)) divided by the probability of finding those certain words in any message (Pr(words)) (b) adjusted or scaled by an Applicability Factor (AF).

In accordance with embodiments of the invention the Applicability Factor (AF) may be based on a source address of the message, a source carrier of the message, a frequency count, and/or a time of day or day of week that the message was sent.

If a given message is determined to be spam, then the messages may be dropped, quarantined, or one or more alert messages may be generated and sent.

These and other features of the embodiments of the present invention, along with their attendant advantages, will be more fully appreciated upon a reading of the following detailed description in conjunction with the associated drawings.

### BRIEF DESCRIPTION OF THE DRAWINGS

FIG. 1 is a diagrammatic presentation of an exemplary Messaging Inter-Carrier Vendor (MICV).

FIG. 2 illustrates one particular arrangement that is possible through aspects of the present invention.

FIG. 3 provides an exemplary catalog of some of the shortcuts that are frequently employed in SMS, MMS, etc. messages.

FIG. 4 illustrates an exemplary sliding window facility that may be employed by aspects of the present invention.

FIG. 5 depicts exemplary calculations under an aspect of the present invention.

FIG. 6 illustrates various of the exchanges or interactions that are supported by aspects of the present invention.

FIG. 7 is a diagrammatic presentation of aspects of an exemplary Service Provider (SP) Application Server (AS).

It should be understood that these figures depict embodiments of the invention. Variations of these embodiments will be apparent to persons skilled in the relevant art(s) based on the teachings contained herein.

### DETAILED DESCRIPTION

The present invention may leverage the capabilities of a centrally-located, full-featured MICV facility. Reference is made to U.S. Pat. No. 7,154,901 entitled “INTERMEDIARY NETWORK SYSTEM AND METHOD FOR FACILITATING MESSAGE EXCHANGE BETWEEN WIRELESS NETWORKS,” and its associated continuations, for a description of a MICV, a summary of various of the services/functions/etc. that are performed by a MICV, and a discussion of the numerous advantages that arise from same. The disclosure of U.S. Pat. No. 7,154,901, along with its associated continuations, is incorporated herein by reference.

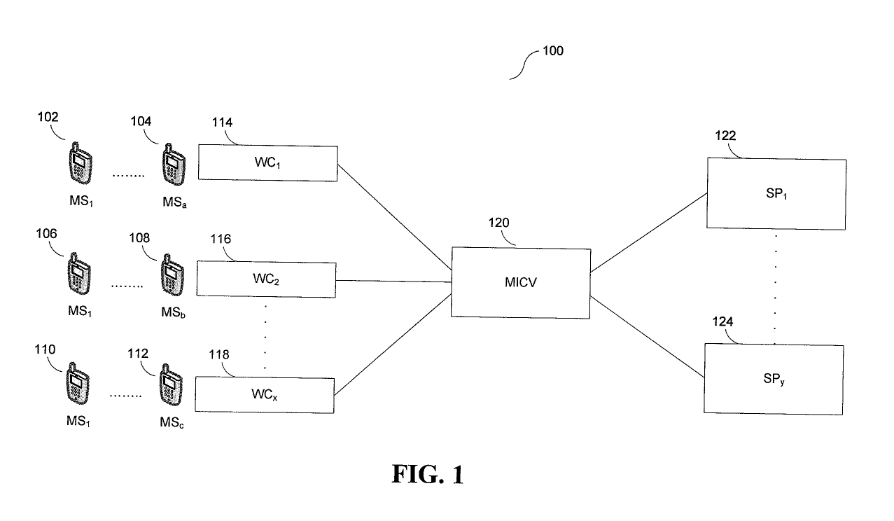

As illustrated in FIG. 1 and reference numeral 100 a MICV 120 is disposed between, possibly inter alia, multiple WCs (WC₁ 114→WCₓ 118) on one side and multiple SPs (SP₁ 122→SP_{y} 124) on the other side and thus ‘bridges’ all of the connected entities. A MICV 120 thus, as one simple example, may offer various routing, formatting, delivery, value-add, etc. capabilities that provide, possibly inter alia:

1) A WC 114→118 (and, by extension, all of the MSs 102→104, 106→108, and 110→112 that are serviced by the WC 114→118) with ubiquitous access to a broad universe of SPs 122→124 and

2) A SP 122→124 with ubiquitous access to a broad universe of WCs 114 →118 (and, by extension, all of the MSs 102→104, 106→108, and 110→112 that are serviced by the WC 114→118).

Generally speaking a MICV may have varying degrees of visibility (e.g., access, etc.) to the (MS⇄MS, MS⇄SP, etc.) messaging traffic:

1) A WC may elect to route just their out-of-network messaging traffic to a MICV. Under this approach the MICV would have visibility (e.g., access, etc.) to just the portion of the WC's messaging traffic that was directed to the MICV by the WC.

2) A WC may elect to route all of their messaging traffic to a MICV. The MICV may, possibly among other things, subsequently return to the WC that portion of the messaging traffic that belongs to (i.e., that is destined for a MS of) the WC. Under this approach the MICV would have visibility (e.g., access, etc.) to all of the WC's messaging traffic.

An implementation that contains a ‘route all of their messaging traffic to a MICV’ option may serve to enhance aspects of the present invention.

While the discussion below will include a MICV it will be readily apparent to one of ordinary skill in the relevant art that other arrangements are equally applicable and indeed are fully within the scope of the present invention.

In the discussion below the present invention is described and illustrated as being offered by a SP. A SP may, for example, be realized as a third-party service bureau, an element of a WC or a landline carrier, an element of a MICV, multiple third-party entities working together, etc.

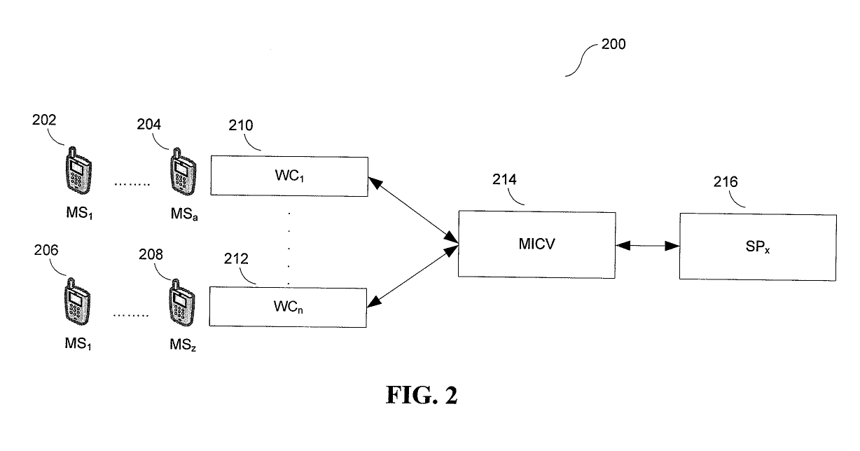

To help explain key aspects of the present invention consider the illustrative example that is depicted through FIG. 2 and the narrative below.

As indicated in FIG. 2 and reference numeral 200 all of the messaging traffic of numerous WCs (WC₁ 210→WCₙ 212) is exchanged with a MICV 214 and the MICV 214 is connected with SPₓ 216 (a SP that offers, possibly inter alia, the present invention). Among other things this provides SPX 216 with visibility (access, etc.) to all of the messaging traffic (to, possibly inter alia, conduct spam detection operations against all of that traffic) and, inter alia, the opportunity (as explained below) to continuously expand its internal repositories, refine the results of its message review and other analytical activities, etc. as time progresses (and as ever more messages are presented to it).

Aspects of the present invention leverage Bayes' Theorem. This theorem, which is well known to those of ordinary skill in the art, relates the conditional and marginal probabilities of two stochastic (or random) events, A and B:

Pr(A|B)(Pr(B|A)*Pr(A))/(Pr(B))

where Pr(A|B) is the conditional probability of A given B; Pr(B|A) is the conditional probability of B given A; Pr(A) is the marginal probability of A; and Pr(B) is the marginal probability of B.

Paul Graham, in his seminal 2002 note “A Plan for Spam,” described an E-mail spam filter that was based on Bayes' Theorem. The core of Graham's Bayesian filter may be summarized as:

Pr(spam|words)=(Pr(words|spam)*Pr(spam))/(Pr(words))

where the probability that an E-mail message is spam given that it contains certain words (i.e., Pr(spam|words)) is equal to the probability of finding those certain words in a spam E-mail message (i.e., Pr(words|spam)) times the probability that any E-mail message is spam (i.e., Pr(spam)) divided by the probability of finding those certain words in any E-mail message (i.e., Pr(words)).

A number of products that seek to target E-mail spam have implemented Graham's Bayesian filter. These products include, inter alia, BogoFilter, CRM114, DSPAM, SpamAssassin, SpamBayes, and SpamProbe.

Aspects of the present invention extend Graham's model to, inter alia, make the model incrementally more flexible and tailor the model to the unique, idiosyncratic, etc. characteristics of a wireless messaging ecosystem. The extended model may be summarized as:

Pr(spam|words)=(Pr(words|spam)*Pr(spam))/(Pr(words))*AF

where the probability that a (SMS, MMS, etc.) message is spam given that it contains certain words (i.e., Pr(spam|words)) is equal to (a) the probability of finding those certain words in a spam (SMS, MMS, etc.) message (i.e., Pr(words|spam)) times the probability that any (SMS, MMS, etc.) message is spam (i.e., Pr(spam)) divided by the probability of finding those certain words in any (SMS, MMS, etc.) message (i.e., Pr(words)) (b) adjusted or scaled by an Applicability Factor (AF).

Within the extended model it is important to note:

1) The option to dynamically adjust the catalog of words (‘words’ in the above formula) that the evaluation process draws upon.

2) The option to include, for example:

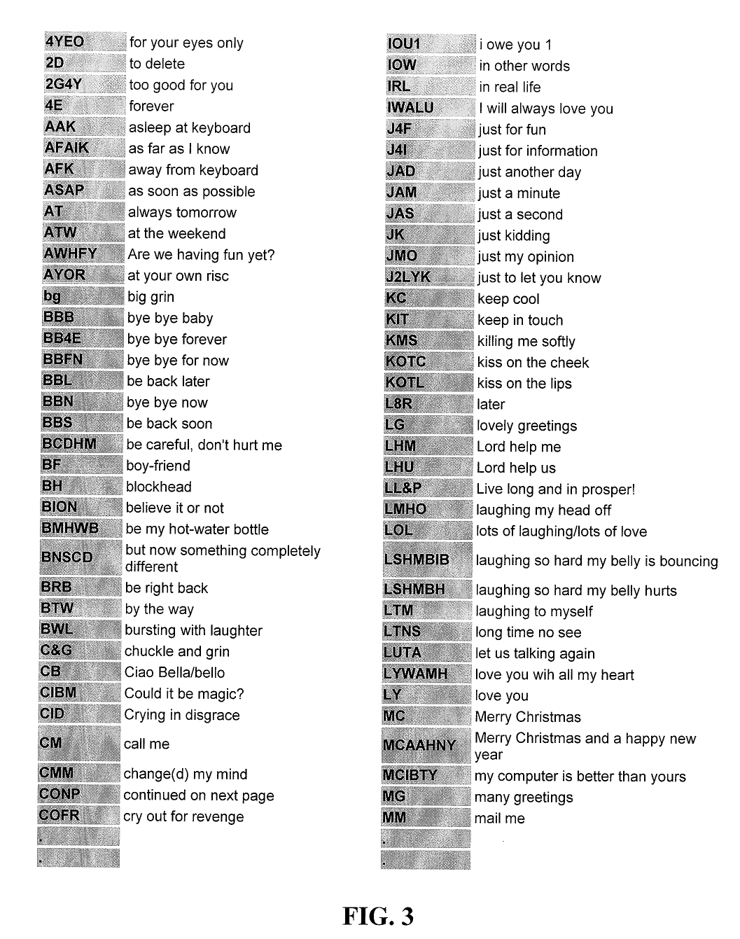

i) Dynamically updateable catalogs of common expressions, shortcuts, idioms, abbreviations, etc. (for example, as illustrated in FIG. 3—“wru” for “Where are you?”, “aamof” for “as a matter of fact”, “w84mi” for “wait for me”, etc.) that frequently are employed in (SMS, MMS, etc.) messages.

ii) Dynamically updateable catalogs of ‘seed’ words (i.e., specific conventional and/or unconventional words that have been identified in previously captured spam SMS, MMS, etc. messages).

3) The option to assign a Sensitivity Factor (SF), indicating possibly inter alia ‘spam’ or ‘not spam,’ to any of the words in the catalogs that were described in 1 and 2 above. As one possible example, a SF may be defined to lie within the range 0←SF←1 (with the boundary values of 0 and 1 indicating ‘no weight’ [for 0] and ‘neutral weight’ [for 1]). As another possible example, a SF may be allowed to span a wider range of values (with, possibly inter alias, an associated modulus or other scaling mechanism to ensure that a final or end calculated value never exceeds a configurable threshold such as 100%).

4) The option to dynamically adjust any of the SFs that were described in 3 above.

5) The optional inclusion of a SF in the calculation or generation of an individual probability (e.g., Pr(words|spam)).

6) The option to dynamically adjust any of the derived probabilities (e.g., Pr(words|spam), etc.).

7) The inclusion of an AF to indicate the relative importance, likelihood of spam, etc. for a (SMS, MMS, etc.) message based on ‘extra’ criteria. For example, an AF may consist of a defined group of, and therefore be calculated or generated by evaluating, one or more of the elements within a flexible, extensible, and dynamically updateable or configurable framework of factors. Potential framework factors might include, possibly inter alia:

i) Source Address (SA). For example one specific message SA (such as, for example, the source Telephone Number [TN], source Short Code [SC] or Common Short Code [CSC], etc.). Or a mix or collection of specific SAs. Or an explicit range of SAs.

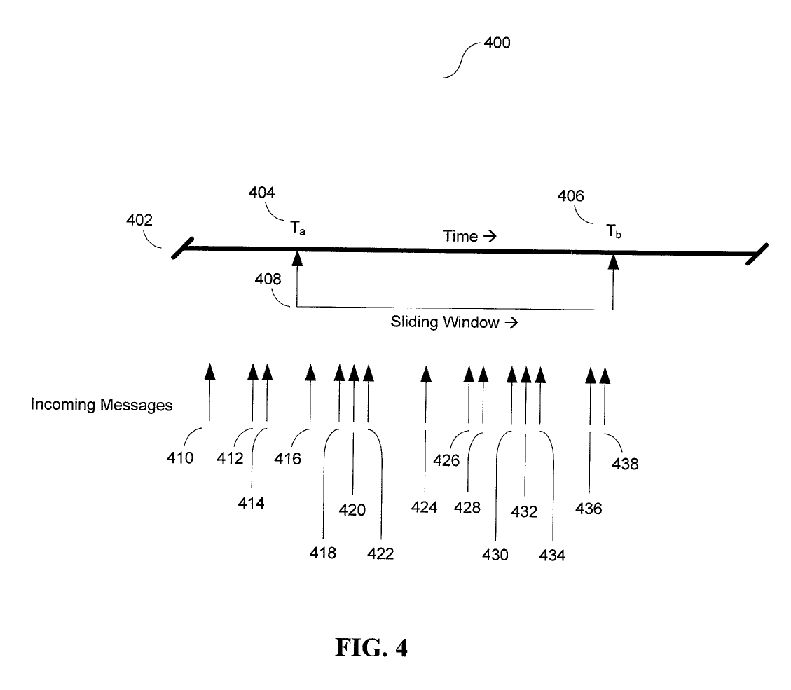

ii) Frequency Count. For example, the number or count of incoming messages (in total, for a specific SA, for an explicit range of SAs, etc.) within a sliding window. A sliding window may be dynamically configurable to be a specific size or duration. An illustrative sliding window facility with incoming messages 410-438 is depicted in FIG. 4 and reference numeral 400.

iii) Time of Day (ToD). For example, the 23 hours of a day—0, 1, 2, . . . , 23, and 24—based on any of several possible reference points (including, possibly inter alia, a local time zone, Greenwich Mean Time, etc.).

iv) Day of Week (DoW). For example, the seven days of a week—Sunday, Monday, . . . , Friday, and Saturday.

v) Source Carrier. For example, one specific source carrier (such as, for example, Verizon Wireless, T-Mobile, etc.). Or a mix or collection of specific source carriers.

The specific framework factors that were described above are illustrative only and it will be readily apparent to one of ordinary skill in the relevant art that numerous other factors are easily possible and indeed are fully within the scope of the present invention.

One or more framework factors may optionally be assigned a Weighting Factor (WF) to incrementally increase or decrease the importance or impact of a factor to that factor's relative contribution to an AF. As one possible example, a WF may be defined to lie within the range 0←WF←1 (with the boundary values of 0 and 1 indicating ‘no weight’ [for 0] and ‘neutral weight’ [for 1]). As another possible example, a WF may be allowed to span a wider range of values (with, possibly inter alias, an associated modulus or other scaling mechanism to ensure that a final or end calculated value never exceeds a configurable threshold such as 100%).

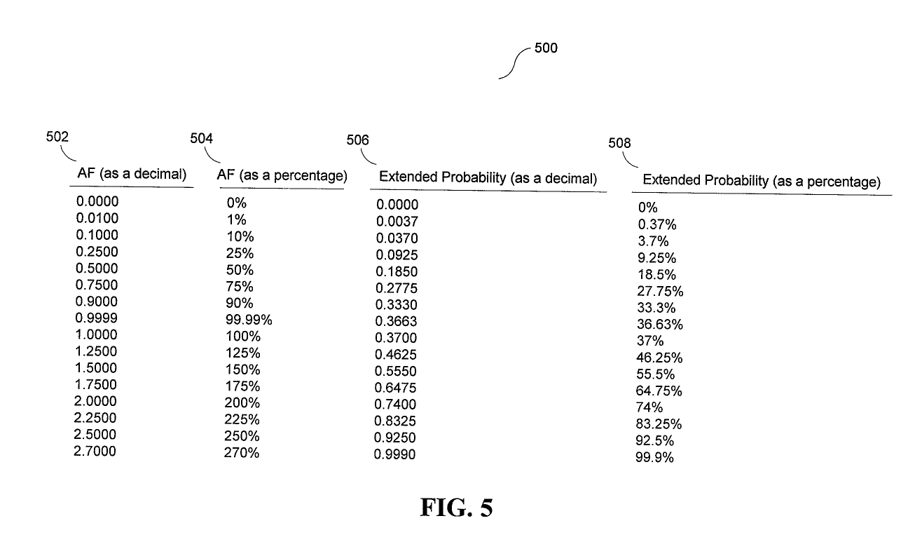

For purposes of illustration consider the following hypothetical example. In this example an initial probability (of a message being spam) was calculated to be 37%. Additionally, an AF has been defined as consisting of two framework factors with each framework factor having an associated WF—(a) SA with a WF of 75% and (b) Frequency Count with a WF of 25%. FIG. 5 and reference numeral 500 illustrate the different extended probabilities (of a message being spam) 506/508 that would arise from a range of AF values 502/504.

Multiple AFs may be defined with, possibly inter alia, a specific AF being automatically or manually enabled or disabled based on one or more criteria including, for example, ToD, DoW, etc.

An AF may optionally default to ‘no impact or effect.’

The AF characteristics that were described above are illustrative only and it will be readily apparent to one of ordinary skill in the relevant art that numerous other options are easily possible (e.g., a modulus or other scaling mechanism may be incorporated to ensure that the value of a calculated probability, when an AF is included, never exceeds a configurable threshold such as 100%) and indeed are fully within the scope of the present invention.

The elements of the extended model that were described above are illustrative only and it will be readily apparent to one of ordinary skill in the relevant art that numerous other options are easily possible (e.g., any or all of the catalogs, calculations, values [such as SF and/or AF], etc. that were described above might optionally be made WC-specific, MICV-specific, etc.) and indeed are fully within the scope of the present invention.

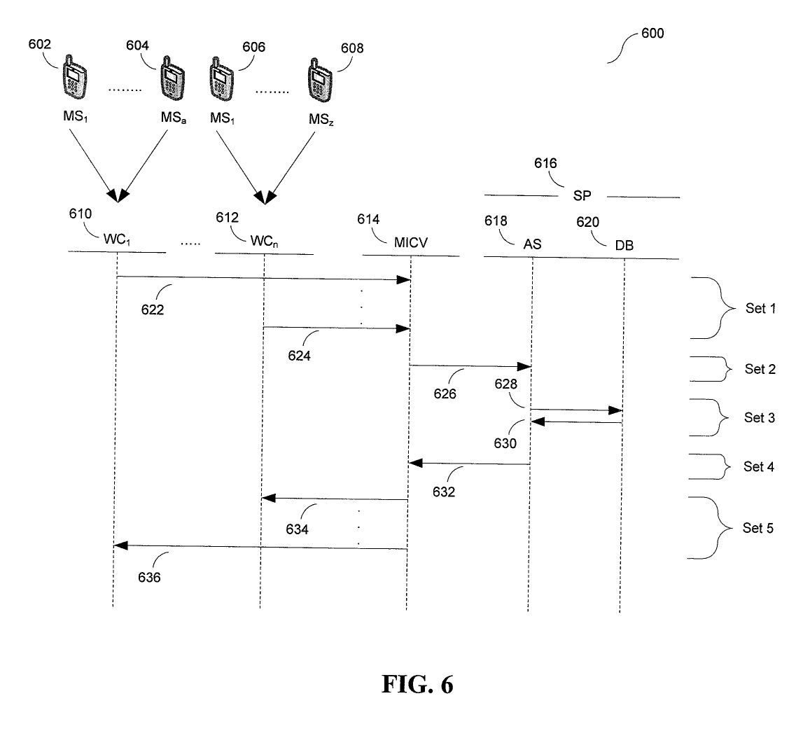

To help explain key aspects of the present invention consider the illustrative interactions that are depicted in FIG. 6 and reference numeral 600 (which capture various of the exchanges or interactions that might occur as [SMS, MMS, etc.] messaging traffic is generated, routed, processed, etc.) Of interest and note in the diagram are the following entities:

MS, 602→MSₐ 604 and MS₁ 606→MS_{z} 608. MS WDs such as a mobile telephones, BlackBerrys, PalmPilots, etc.

WC₁ 610→WCₙ 612. Numerous WCs.

MICV 614. As noted above the use of a MICV, although not required, provides significant advantages.

SP 616 AS 618. Facilities that provide key elements of the instant invention (which will be described below).

SP 616 Database (DB) 620. One or more data repositories that are leveraged by the AS 618 of SP 616.

In the discussion to follow reference is made to messages that are sent, for example, between a MS 602→604/606→608 and an SP 616. As set forth below, a given “message” sent between a MS 602→604/606→608 and a SP 616 may actually comprise a series of steps in which the message is received, forwarded and routed between different entities, including a WD associated with a MS 602→604/606→608, a WC 610→612, a MICV 614, and a SP 616. Thus, unless otherwise indicated, it will be understood that reference to a particular message generally includes that particular message as conveyed at any stage between an origination source, such as a WD of a MS 602→604/606→608, and an end receiver, such as a SP 616. As such, reference to a particular message generally includes a series of related communications between, for example, a MS 602→604/606→608 and a WC 610→612, the WC 610→612 and a MICV 614, and the MICV 614 and a SP 616. The series of related communications may, in general, contain substantially the same information, or information may be added or subtracted in different communications that nevertheless may be generally referred to as a same message. To aid in clarity, a particular message, whether undergoing changes or not, is referred to by different reference numbers at different stages between a source and an endpoint of the message.

In FIG. 6 the exchanges that are collected under the designation Set 1 and Set 2 represent the activities that might take place as (SMS, MMS, etc.) messages are routed by the various WCs 610→612 to a MICV 614 (via 622→624) and then directed, by the MICV 614, to a SP 616 (via 626). It is important to note these exchanges are illustrative only and it will be readily apparent to one of ordinary skill in the relevant art that numerous other exchanges are easily possible and indeed are fully within the scope of the present invention.

In FIG. 6 the exchanges that are collected under the designation Set 3, Set 4, and Set 5 represent the activities that might take place as (SMS, MMS, etc.) messages are processed by SP 616 (specifically, by an AS 618 of SP 616). To provide context for our review of the Set 3, Set 4, and Set 5 exchanges we take a brief detour to describe an illustrative SP AS.

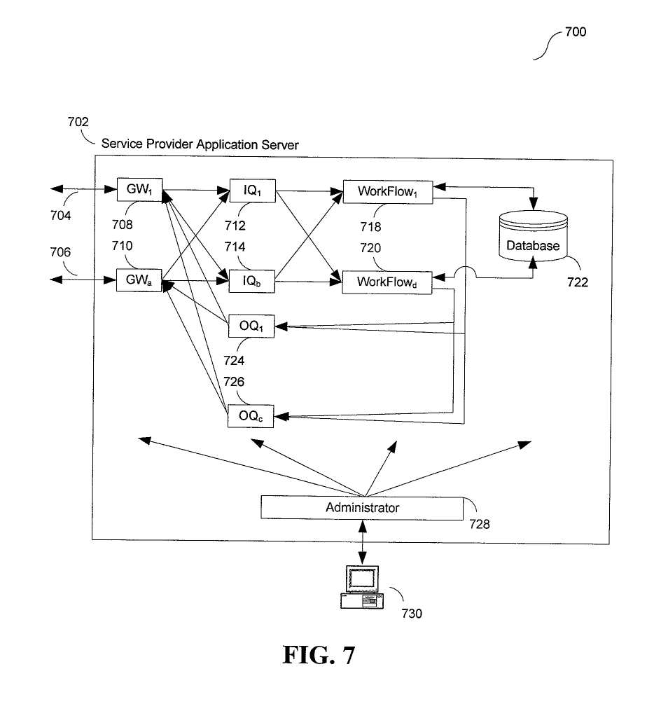

FIG. 7 and reference numeral 700 provide a diagrammatic presentation of aspects of an exemplary SP AS 702. The illustrated AS 702 contains several key components—Gateways (GW₁ 708→GWₐ 710 in the diagram), Incoming Queues (IQ₁ 712→IQ_{b} 714 in the diagram), WorkFlows (WorkFlow₁ 718→WorkFlow_{d} 720 in the diagram), Database 722, Outgoing Queues (OQ₁ 724→OQ_{c} 726 in the diagram), and an Administrator 728. It will be readily apparent to one of ordinary skill in the relevant art that numerous other components are possible within an AS.

A dynamically updateable set of one or more Gateways (GW₁ 708→GWₐ 710 in the diagram) handle incoming (e.g., SMS/MMS/IMS/etc. messaging, etc.) traffic 704/706 and outgoing (e.g., SMS/MMS/IMS/etc. messaging, etc.) traffic 704/706. Incoming traffic 704/706 is accepted and deposited on an intermediate or temporary Incoming Queue (IQ₁712→IQ_{b} 714 in the diagram) for subsequent processing. Processed artifacts are removed from an intermediate or temporary Outgoing Queue (OQ₁724→OQ_{c} 726 in the diagram) and then dispatched 704/706.

A dynamically updateable set of one or more Incoming Queues (IQ₁ 712→IQ_{b} 714 in the diagram) and a dynamically updateable set of one or more Outgoing Queues (OQ₁ 724→OQ_{c} 726 in the diagram) operate as intermediate or temporary buffers for incoming and outgoing traffic 704/706.

A dynamically updateable set of one or more WorkFlows (WorkFlow₁ 718→WorkFlow_{b} 720 in the diagram) remove incoming traffic from an intermediate or temporary Incoming Queue (IQ₁ 712→IQ_{b} 714 in the diagram), perform all of the required processing operations (explained below), and deposit processed artifacts on an intermediate or temporary Outgoing Queue (OQ₁ 724→OQ_{c} 726 in the diagram). The WorkFlow component will be described more fully below.

The Database 722 that is depicted in FIG. 7 is a logical representation of the possibly multiple physical repositories that may be implemented to support, inter alia, configuration, word catalog, calculation, etc. information. The physical repositories may be implemented through any combination of conventional Relational Database Management Systems (RDBMSs) such as Oracle, through Object Database Management Systems (ODBMSs), through in-memory Database Management Systems (DBMSs), or through any other equivalent facilities.

An Administrator 728 provides management or administrative control over all of the different components of an AS through, as one example, a World Wide Web (WWW)-based interface 730. It will be readily apparent to one of ordinary skill in the relevant art that numerous other interfaces (e.g., a data feed, an Application Programming Interface [API], etc.) are easily possible.

Through flexible, extensible, and dynamically updatable configuration information a WorkFlow component may be quickly and easily realized to support any number of activities. For example, WorkFlows might be configured to support the receipt and processing of incoming (SMS, MMS, IM, etc.) messages; to support the calculation of probabilities (as, for example, described above in connection with the extended model); to support the generation and dispatch of outgoing alert, update, etc. messages; to support the generation of scheduled and/or on-demand reports; etc. The specific WorkFlows that were just described are exemplary only; it will be readily apparent to one of ordinary skill in the relevant art that numerous other WorkFlow arrangements, alternatives, etc. are easily possible.

A SP may maintain a repository (e.g., a database) into which selected details of all administrative, messaging, processing, etc. activities may be recorded. Among other things, such a repository may be used to support:

1) Scheduled (e.g., daily, weekly, etc.) and/or on-demand reporting with report results delivered through SMS, MMS, IMS, etc. messages; through E-mail; through a WWW-based facility; etc.

2) Scheduled and/or on-demand data mining initiatives (possibly leveraging or otherwise incorporating one or more external data sources) with the results of same presented through visualization, Geographic Information System (GIS), etc. facilities and delivered through SMS, MMS, IMS, etc. messages; through E-mail; through a WWW-based facility; etc.

Over time as ever more messages are presented to a SP the SP may continuously expand the depth and/or the breadth of its internal repositories, and consequently incrementally refine, improve, etc. the quality, etc. of its message review and other analytical activities.

Returning to FIG. 6 . . . the processing activities that are depicted under the designation Set 3, Set 4, and Set 5 might include possibly inter alia (via, among other things, 628→630):

A) Retrieving an incoming message from an IQ.

B) Extracting from a received message, and optionally validating/etc., various data elements including, inter alia, the SA (such as, for example, the source TN), the Destination Address (such as, for example, the destination TN), the message content or body, etc.

C) Preserving various elements of the received message in a Messages database table.

D) Updating a MS database table, as appropriate and as required, to ensure that an entry exists for the SA (such as, for example, the TN) of the message.

E) Performing one or more analytical steps. The analytical steps may be realized through a combination of:

i) Flexible, extensible, and dynamically configurable Workflows (as previously described) that implement the rules, logic, etc. for a range of methods (including, inter alia, statistical, keyword matching, stylistic, linguistic, heuristic, etc.) that implement the extended model—Pr(spam|words)=(Pr(words|spam)*Pr(spam))/(Pr(words))*AF—as described above.

ii) Dynamically updateable data sources (including, possibly inter alia, the catalog of words and the catalog of common expressions/shortcuts/idioms/abbreviations/etc. that were described above).

and may, among other things, optionally score, rate, rank, etc. the developed results; optionally augment the developed results with such things like demographic, geographic, etc. data; etc.

F) Generating one or more indicators. Indicators may capture, inter alia, specific characteristics (such as ‘this message is spam’), patterns, traits, features, etc.

G) Preserving one or more of the generated indicators in an Indicators database table.

H) Leveraging a flexible, extensible, and dynamically configurable list of defined events (e.g, as maintained in an EventDefinitions database table) to generate one or more events. Events may include, inter alia, alerting one or more parties (such as, for example, a WC, a MICV, etc.) to the presence of a spam message through any combination of one or more channels such as SMS/MMS/etc. messages, E-mail messages, IM messages, data feeds; optionally blocking a spam message; etc.

I) Depositing one or more of the generated events on an OQ.

J) Preserving one or more of the generated events in an Events database table.

K) Depositing, consistent with the generated indicator(s) and event(s), the incoming message on an OQ (for dispatch, e.g., first back to a MICV 614 [via 632] and then back to the appropriate WC 610→612 [via 634→636] for final delivery to the appropriate WD 602→604 and 606→608). For example, if an incoming message is not identified as spam then it may be deposited on an OQ. Alternatively, if an incoming message is identified as spam it may, depending upon previously-identified MICV and/or WC preferences, be blocked or dropped (and hence not deposited on an OQ).

The catalog of processing steps that were described above are illustrative only and it will be readily apparent to one of ordinary skill in the relevant art that numerous other processing steps (such as, possibly inter alia, scoring, ranking, rating, etc. one or more of the generated indicators) are easily possible and indeed are fully within the scope of the present invention. For example:

1) An incoming message that is identified as spam may optionally be ‘quarantined’ for, possibly inter alia, subsequent review (by representatives of a MICV, a WC, etc.).

2) An incoming message that is identified as spam may optionally result in one or more outgoing (SMS, MMS, etc.) alert, notification, etc. messages (to, for example, one or more representatives of a MICV, a WC, etc.).

3) For reasons of performance, one or more date/time-specific Training Windows may optionally be defined for, possibly inter alia, a WC, a MICV, etc. Incoming messages that are retrieved from an IQ may optionally bypass one or more of the processing activities that were described above (the specific steps to be bypassed being configurable within a Training Window) if the receipt of those messages lies outside of an applicable Training Window.

4) Various of the elements that were described above might optionally be made WC-specific, MICV-specific, etc.

5) An optional registration process may be provided (through, possibly inter alia, a WWW site, an exchange of SMS/MMS/etc. messages, an Interactive Voice Response [IVR] facility, an exchange of E-mail messages, etc.) by which, possibly inter alia, one or more representatives of a MICV, a WC, etc. may identify themselves, provide contact information, etc.

It is important to note the exchanges that were described above (as residing under the designation Set 3, Set 4, and Set 5) are illustrative only and it will be readily apparent to one of ordinary skill in the relevant art that numerous other exchanges are easily possible and indeed are fully within the scope of the present invention.

It will be readily apparent to one of ordinary skill in the relevant art that numerous alternatives to the arrangements that were described above are easily possible.

The various alert, notification, report, etc. message(s) that were described above may optionally contain an informational element—e.g., a service announcement, a relevant or applicable factoid, etc. The informational element may be selected statically (e.g., all generated messages are injected with the same informational text), selected randomly (e.g., a generated message is injected with informational text that is randomly selected from a pool of available informational text), or location-based (i.e., a generated message is injected with informational text that is selected from a pool of available informational text based on the current physical location of the recipient of the message as derived from, as one example, a Location-Based Service (LBS)/Global Positioning System (GPS) facility).

A SP may optionally allow advertisers to register and/or provide (e.g., directly, or through links/references to external sources) advertising content.

The provided advertising content may optionally be included in various of the message(s) that were described above—e.g., textual material if an SMS model is being utilized, multimedia (images of brand logos, sound, video snippets, etc.) material if an MMS model is being utilized, etc. The advertising material may be selected statically (e.g., all generated messages are injected with the same advertising material), selected randomly (e.g., a generated message is injected with advertising material that is randomly selected from a pool of available material), or location-based (i.e., a generated message is injected with advertising material that is selected from a pool of available material based on the current physical location of the recipient of the message as derived from, as one example, a LBS/GPS facility).

The message(s) that were described above may optionally contain promotional materials, coupons, etc. (via, possibly inter alia, text, still images, video clips, etc.).

It is important to note that while aspects of the discussion that was presented above focused on the use of TNs, SCs, etc. it will be readily apparent to one of ordinary skill in the relevant art that other message address identifiers are equally applicable and, indeed, are fully within the scope of the present invention.

The discussion that was just presented referenced several specific wireless messaging paradigms including SMS, MMS, IMS, etc. However, it is to be understood that it would be readily apparent to one of ordinary skill in the relevant art that other messaging paradigms are fully within the scope of the present invention.

It is important to note that the hypothetical example that was presented above, which was described in the narrative and which was illustrated in the accompanying figures, is exemplary only. It is not intended to be exhaustive or to limit the invention to the specific forms disclosed. It will be readily apparent to one of ordinary skill in the relevant art that numerous alternatives to the presented example are easily possible and, indeed, are fully within the scope of the present invention.

The following list defines acronyms as used in this disclosure.

| Acronym | Meaning |
|---|---|
| AF | Applicability Factor |
| API | Application Programming Interface |
| AS | Application Server |
| CAN-SPAM | Controlling the Assault of Non-Solicited Pornography and |
| | Marketing |
| CSC | Common Short Code |
| DB | Database |
| DBMS | Database Management System |
| DoW | Day of Week |
| E-mail | Electronic Mail |
| GIS | Geographic Information System |
| GPS | Global Positioning System |
| GW | Gateway |
| IM | Instant Messenger |
| IMS | IP Multimedia Subsystem |
| IP | Internet Protocol |
| IQ | Incoming Queue |
| IVR | Interactive Voice Response |
| LBS | Location Based Services |
| MICV | Messaging Inter-Carrier Vendor |
| MMS | Multimedia Message Service |
| MS | Mobile Subscriber |
| ODBMS | Object Database Management System |
| OQ | Outgoing Queue |
| RDBMS | Relational Database Management System |
| SA | Source Address |
| SC | Short Code |
| SF | Sensitivity Factor |
| SMS | Short Message Service |
| SP | Service Provider |
| TN | Telephone Number |
| ToD | Time of Day |
| WAP | Wireless Application Protocol |
| WC | Wireless Carrier |
| WD | Wireless Device |
| WF | Weighting Factor |
| WWW | World-Wide Web |

What is claimed is:

1. A method for controlling spam within a wireless ecosystem, comprising:
receiving a plurality of messages passing through a wireless ecosystem, the messages being considered received messages;
performing one or more analytic steps on the received messages including applying an extended model;
generating one or more indicators in view of results of the analytic steps;
generating one or more events in view of the indicators and a list of previously defined events; and
disposing of the received messages consistent with the generated events.

2. The method of claim 1, wherein elements of one or more of (a) the received messages, (b) the results of the analytic steps, (c) the indicators, (d) the events, and/or (e) the disposition of the received messages are preserved in a repository.

3. The method of claim 1, wherein received messages that are identified as spam result in one or more of (a) the dropping of the received message, (b) the quarantine of the received message and/or (c) the generation of one or more alert messages.

4. The method of claim 1, wherein the extended model supports one or more of (a) an adjustable catalog of words, (b) an updateable catalog of common expressions, shortcuts, idioms, and abbreviations, and (c) an updateable catalog of seed words.

5. The method of claim 4, wherein a sensitivity factor is maintained for entries of a one or more of the catalogues.

6. The method of claim 5, wherein a sensitivity factor is employed to calculate a probability of whether a given received message is spam.

7. The method of claim 1, wherein the extended model supports an applicability factor.

8. The method of claim 7, wherein the applicability factor includes one or more of (a) source address, (b) frequency count, (c) time of day, (d) day of week, and/or (e) source carrier.

9. The method of claim 8, wherein a weighting factor is maintained for an element of an applicability factor.

10. The method of claim 8, wherein the frequency count is developed through a sliding window.

11. The method of claim 1, further comprising establishing a Training Window during which variables associated with the extended model are set.

12. A method for detecting undesirable messages being passed through a wireless network, comprising:
intercepting a message at a messaging inter-carrier vendor (MICV) that was sent over a wireless network;
passing the message to an application server that is in communication with a database and calculating by the application server a probability that the message is an undesirable message,
wherein the calculating comprises analyzing one or more of words, expressions, shortcuts, idioms, and abbreviations, in the message.

13. The method of claim 12, wherein the probability is based on the formula
Pr(spam|words)=(Pr(words|spam)*Pr(spam))/(Pr(words))*AF
wherein the probability that the message is undesirable (spam) given the message includes certain words is equal to (a) the probability of finding those certain words in an undesirable message (Pr(words|spam)) times the probability that any message is undesirable (Pr(spam)) divided by the probability of finding those certain words in any message (Pr(words)) (b) adjusted or scaled by an Applicability Factor (AF).

14. The method of claim 13, further comprising assigning a Sensitivity Factor to at least one of the words.

15. The method of claim 13, wherein the Applicability Factor is based on a source address of the message.

16. The method of claim 13, wherein the Applicability Factor is based on a source carrier of the message.

17. The method of claim 13, wherein the Applicability Factor is based on a frequency count.

18. The method of claim 13, wherein the Applicability Factor is based on a time of day or day of week that the message was sent.

19. The method of claim 13, wherein the message is an SMS message.

20. The method of claim 13, wherein the message is an MMS message.
